(19) United States
(12) Patent Application Publication
(10) Pub. No.: US 2020/0284286 A1
(43) Pub. Date: Sep. 10, 2020

(54) Self-Drilling Ground Screw

(71) Applicant: Richard Lanz, Saint Paul, MN (US)

(72) Inventor: Richard Lanz, Saint Paul, MN (US)

(21) Appl. No.: 16/515,362

(22) Filed: Jul. 18, 2019

Related U.S. Application Data
(60) Provisional application No. 62/814,020, filed on Mar. 5, 2019.

(51) Int. Cl. F16B 25/10; F16B 25/00; F16B 23/00; H01R 4/56; H01R 4/66

(52) U.S. Cl. CPC F16B 25/103; F16B 25/0047; F16B 23/0015; H01R 4/66; F16B 23/0038; H01R 4/56; F16B 23/0023

(57) ABSTRACT

A self-drilling ground screw for electrical grounding. The self-drilling ground screw includes a shaft having a proximal end and a distal end, wherein a head is affixed to the proximal end. The shaft further includes a threaded portion and a drill bit portion thereon, wherein threading is disposed about the shaft along the threaded portion. The drill bit portion includes spiral cutting edges therealong. A protrusion extends from the distal end, wherein the protrusion tapers to a point.

### CROSS REFERENCE TO RELATED APPLICATIONS

This application claims the benefit of U.S. Provisional Application No. 62/814,020 filed on Mar. 5, 2019. The above identified patent application is herein incorporated by reference in its entirety to provide continuity of disclosure.

### BACKGROUND OF THE INVENTION

The present invention relates to self-drilling ground screws. More particularly, the present invention pertains to self-drilling ground screws having a threaded portion and a drill bit portion along a shaft thereof, wherein a pointed protrusion extends from a distal end of the shaft.

Many people, such as electricians, carpenters, and handymen, regularly install grounding connections. These grounding connections are typically important to provide safety and functionality to various electrical systems and the like. Generally grounding connections are made by drilling into a substrate, such as an electrical box, and then subsequently screwing a ground screw into the hole, and then affixing a ground wire to the ground screw. This can take a significant amount of time and be quite labor intensive, as the user must change tools and equipment several times during the process, moving from a drill, to a screwdriver, and then securing a ground wire to each screw in the process. Therefore, a device that allows user to simultaneously drill a pilot hole for the ground screw and affix the ground screw to the substrate is desired.

In light of the devices disclosed in the known art it is submitted that the present invention substantially diverges in design elements from the known art and consequently it is clear that there is a need in the art for an improvement to existing ground screws. In this regard, the instant invention substantially fulfills these needs.

### SUMMARY OF THE INVENTION

In view of the foregoing disadvantages inherent in the known types of ground screws now present in the known art, the present invention provides a self-drilling ground screw wherein the same can be utilized for providing convenience for the user when securing a ground screw within a substrate while simultaneously drilling a pilot hole for the screw.

The present device comprises a shaft having a proximal end and a distal end, wherein a head is affixed to the proximal end. The shaft comprises a threaded portion and a drill bit portion, wherein threading is disposed about the shaft along the threaded portion. The drill bit portion comprises spiral cutting edges therealong. A protrusion extends from the distal end, wherein the protrusion tapers from the distal end to a point to aid in drilling a pilot hole.

In some embodiments, the self-drilling ground screw further comprises a flange extending orthogonally from a base of the head, the flange configured to rest flush against a substrate when the screw is secured thereto such that a grounding wire can be secured thereunder. In this embodiment, the flange includes a planar lower surface. In another embodiment, the flange includes a rounded upper side.

In some embodiments, a plurality of cutouts is disposed on the head, wherein each of the plurality of cutouts is configured to operably engage a screwdriver therein. In yet another embodiment, the plurality of cutouts is selected from a group including, but not limited to, a flathead cutout, a Phillips head cutout, and a hex cutout. In some embodiments, each of the plurality of cutouts is concentric. In another embodiment, the head comprises a hexagonal cross-section configured to be operably engaged by a wrench. In some embodiments, the protrusion comprises a diameter less than that of the drill bit portion. In yet another embodiment, the protrusion is concentric with the shaft. In some embodiments, the threading comprises a fin cut having angular sides of equal length. In another embodiment, the threaded portion extends along a majority of a length of the shaft. In other embodiments, the protrusion further comprises a spiraling shape defining cutting edges thereon. In yet another embodiment, the cutting edges of the protrusion and the spiral cutting edges of the drill bit portion are angularly offset.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the self-drilling ground screw.

FIG. 2 shows a side view of an embodiment of the self-drilling ground screw.

FIG. 3 shows a top plan view of an embodiment of the self-drilling ground screw.

FIG. 4 shows a bottom plan view of an embodiment of the self-drilling ground screw.

FIG. 5 shows a close-up view of the threading of an embodiment of the self-drilling ground screw.

### DETAILED DESCRIPTION OF THE INVENTION

Reference is made herein to the attached drawings. Like reference numerals are used throughout the drawings to depict like or similar elements of the self-drilling ground screw. The figures are intended for representative purposes only and should not be considered to be limiting in any respect.

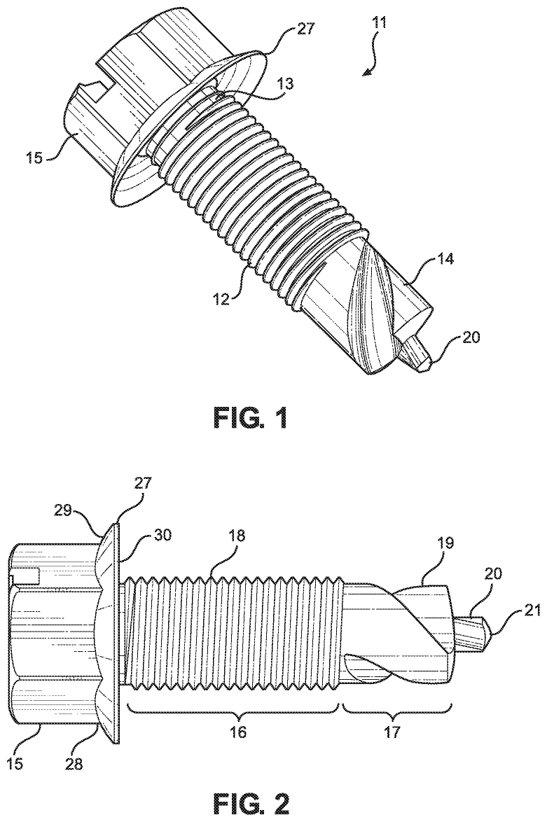

Referring now to FIG. 1, there is shown a perspective view of an embodiment of the self-drilling ground screw. The self-drilling ground screw 11 comprises a shaft 12 having a proximal end 13 opposite a distal end 14. A head 15 is disposed on the proximal end 13, wherein the head 15 is configured to operably receive a tool thereon to facilitate securement of the self-drilling ground screw 11 within a substrate, such as an electrical box, ground surface, or the like. A flange 27 extends orthogonally from the head 15 at a position adjacent to the proximal end 13, wherein the flange 27 is configured to rest flush against the substrate when the self-drilling ground screw 11 is secured therein. In this way a grounding wire can be secured beneath the flange 27 to provide a grounding connection. In the illustrated embodiment, the flange 27 comprises a hollow interior, however, in alternate embodiments, the flange 27 comprises a solid construction to improve durability thereof, while providing a planar lower surface against which a grounding wire can rest to properly provide a grounding connection. A protrusion 20 extends from the distal end 14, wherein the protrusion 20 is configured to form a pilot hole within the substrate to facilitate easier drilling therethrough. In some embodiments, an entirety of the self-drilling ground screw 11 comprises a conductive material such that a proper grounding connection is formed when a grounding wire is affixed thereto.

Referring now to FIG. 2, there is shown a side view of an embodiment of the self-drilling ground screw. The shaft further comprises a threaded portion 16 and a drill bit portion 17 thereon. The threaded portion 16 comprises threading 18 helically wrapped about the shaft therealong, wherein the threading 18 is configured to removably secure the shaft within the substrate. The drill bit portion 17 comprises a spiraling form factor defining spiral cutting edges 19 thereon. The spiral cutting edges 19 are configured to remove material from a substrate to define a hole therein akin to traditional drill bits. In the illustrated embodiment, the threaded portion 16 extends along a majority of the shaft. In this way, maximal securement within the substrate is ensured. In some embodiments, the threading 18 is aligned with the spiral cutting edges 19 at a transition between the threaded portion 16 and the drill bit portion 17, such that installation of the self-drilling ground screw within a substrate readily transitions between drilling therethrough and securing therein. In this way, a singular rotational force applied to the self-drilling ground screw forms the hole in which the ground screw is simultaneously secured.

In the illustrated embodiment the protrusion 20 tapers opposite the distal end of the shaft to define a point 21 thereon. The point 21 is configured to initiate the drilling process within the substrate. In this way the protrusion 20 forms an initial pilot hole within the substrate to properly seat the drill bit portion 17 therein, such that the hole can be widened to a desired size to receive the threaded portion 16 therein. In the illustrated embodiment, the protrusion 20 is aligned with the shaft, such that the shaft and the protrusion 20 are concentric.

In the illustrated embodiment, the head 15 further comprises a flange 27 extending orthogonally from a base 28 of the head 15. In some embodiments, the flange 27 comprises a planar lower surface 30 configured to rest flush against the substrate when the ground screw is secured therein. In this way, the flange 27 can operably receive a grounding wire thereunder, allowing a user to create a ground connection therewith. This allows a greater area of the grounding wire to be in contact with the flange 27 than in embodiments having a flange 27 with a hollow interior as shown in FIG. 1. In the illustrated embodiment, the flange 27 further comprises a rounded upper side 29, wherein the rounded upper side 29 provides additional durability to the flange 27, preventing deformation thereof during the installation process. In this way, the s is ensured a solid grounding connection is formed, as consistent contact with a grounding wire is made thereby.

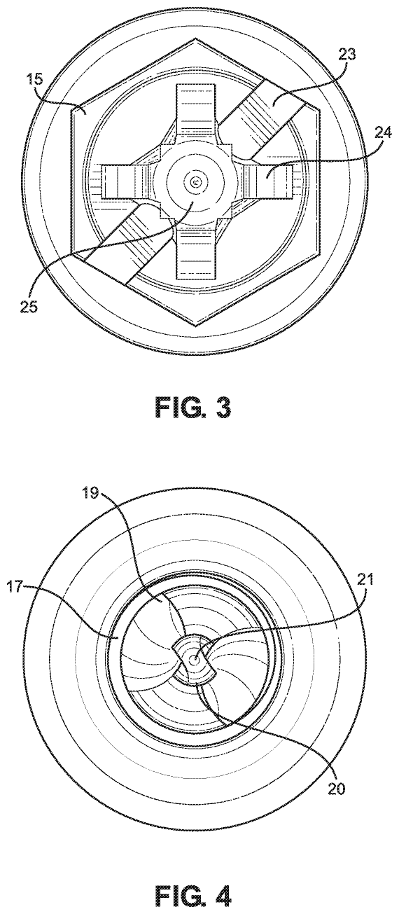

Referring now to FIG. 3, there is shown a top plan view of an embodiment of the self-drilling ground screw. In the illustrated embodiment, the head 15 further comprises a hexagonal cross-section, such that the head 15 is configured to operably engage a wrench. Furthermore, in the shown embodiment, the head 15 includes a plurality of cutouts therein, wherein the plurality of cutouts are each configured to operably engage an operable end of a screwdriver. In the illustrated embodiment, the plurality of cutouts comprise a flathead cutout 23, a Phillips head cutout 24, and a hex cutout 25, however alternate cutouts configured to receive other typical screwdriver heads known in the art are also contemplated.

In some embodiments, the plurality of cutouts are disposed concentrically within the head 15, such that each cutout produces an evenly distributed rotational force through the ground screw. In some embodiments, each of the plurality of cutouts is disposed at a different depth within the head 15, such that each of the cutouts is readily identifiable. In this way, the user can utilize various different tools for providing rotational force to the head 15 in order to simultaneously drill and secure the ground screw within a substrate.

Referring now to FIG. 4, there is shown a bottom plan view of an embodiment of the self-drilling ground screw. The protrusion 20 is disposed on the distal end of the shaft and tapers to form a point 21 thereon. In the illustrated embodiment, the protrusion 20 is disposed concentrically with the drill bit portion 17 to provide proper positioning for a pilot hole to be expanded by the drill bit portion 17. In the illustrated embodiment, the protrusion 20 comprises a spiral cress-section similar to the drill bit portion 17, such that the spiral of the protrusion 20 defines additional cutting edges thereon. The additional cutting edges further aid in the formation of the pilot hole. In the shown embodiment, the spiraling of the protrusion 20 is angularly offset from the spiraling of the drill bit portion 17, such that the material expunged from the substrate by the protrusion 20 to form the pilot hole can be evacuated along the drill bit portion 17.

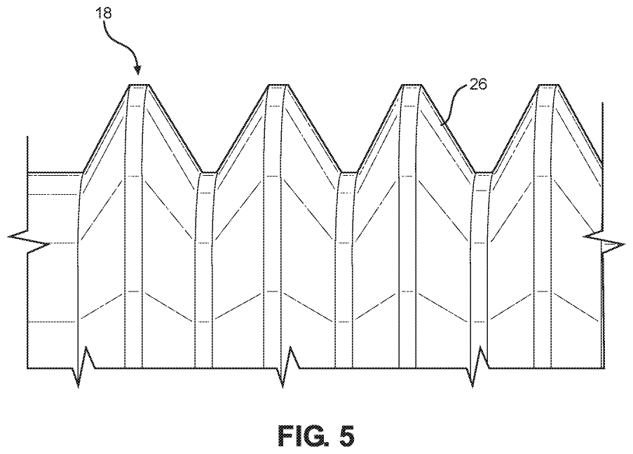

Referring now to FIG. 5, there is shown a close-up view of the threading of an embodiment of the self-drilling ground screw. In the illustrated embodiment, the threading 18 comprises a fin cut, such that the threading 18 includes angular sides 26 having equal lengths. In this way, the threading 18 is configured to provide greater securement within the substrate. Alternatively, other forms of threading 18 known in the art are contemplated and may be used to comply with desired characteristics thereof. Additionally, certain safety requirements, building codes, and regulations, such as the National Electrical Code (NEC), may require specific types of threading 18 to be used.

In one exemplary use, the user identifies where along a substrate a grounding screw must be installed and places the point of the protrusion at that location. The user then engages the head of the ground screw with a tool, such as a wrench or screwdriver, to impart rotational force through the shaft such that a pilot hole is formed by the protrusion. The drill bit portion of the ground screw then widens the pilot hole to a desired diameter to receive the threaded portion therein. The threading is then secured within the hole immediately following the hole is drilled, such that the user is not required to switch tools. A grounding wire can then be secured beneath the head or flange in order to provide a proper grounding connection.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A self-drilling ground screw, comprising:
a shaft having a proximal end and a distal end;
a head affixed to the proximal end of the shaft;
wherein the shaft comprises a threaded portion on a proximal portion thereof and a drill bit portion on a distal portion thereof;
wherein the drill bit portion comprises spiral cutting edges therealong and a protrusion extending therefrom; and
wherein the protrusion tapers from the distal end to define a point.

2. The self-drilling ground screw of claim 1, further comprising a plurality of cutouts disposed on the head, wherein each of the plurality of cutouts is configured to operably engage a screwdriver therein.

3. The self-drilling ground screw of claim 2, wherein each of the plurality of cutouts is selected from a group consisting of a flathead cutout, a Phillips head cutout, and a hex cutout.

4. The self-drilling ground screw of claim 2, wherein each of the plurality of cutouts is concentric.

5. The self-drilling ground screw of claim 1, wherein the head comprises a hexagonal cross-section configured to be operably engaged by a wrench.

6. The self-drilling ground screw of claim 1, wherein the protrusion comprises a diameter less than a diameter of the drill bit portion.

7. The self-drilling ground screw of claim 1, wherein the protrusion is concentric with the shaft.

8. The self-drilling ground screw of claim 1, wherein a threading of the threaded portion comprises a fin cut having angular sides of equal length.

9. The self-drilling ground screw of claim 1, wherein the threaded portion extends along a majority of the shaft.

10. The self-drilling ground screw of claim 1, wherein the protrusion further comprises a spiraling shape defining cutting edges thereon.

11. The self-drilling ground screw of claim 10, wherein the cutting edges of the protrusion and the spiral cutting edges of the drill bit portion are angularly offset.

12. A self-drilling ground screw, comprising:
a shaft having a proximal end and a distal end;
a head affixed to the proximal end of the shaft;
a flange extending orthogonally from a base of the head;
wherein the flange comprises a planar lower side configured to rest flush against a substrate when the self-drilling ground screw is engaged therewith;
wherein the shaft comprises a threaded portion on a proximal portion thereof and a drill bit portion on a distal portion thereof;
wherein the drill bit portion comprises spiral cutting edges therealong and a protrusion extending therefrom; and
wherein the protrusion tapers from the distal end to define a point.

13. The self-drilling ground screw of claim 12, further comprising a plurality of cutouts disposed on the head, wherein each of the plurality of cutouts is configured to operably engage a screwdriver therein.

14. The self-drilling ground screw of claim 13, wherein each of the plurality of cutouts is selected from a group consisting of a flathead cutout, a Phillips head cutout, and a hex cutout.

15. The self-drilling ground screw of claim 13, wherein each of the plurality of cutouts is concentric.

16. The self-drilling ground screw of claim 12, wherein the head comprises a hexagonal cross-section configured to engage a wrench.

17. The self-drilling ground screw of claim 12, wherein the protrusion comprises a diameter less than that of the drill bit portion.

18. The self-drilling ground screw of claim 12, wherein the protrusion is concentric with the shaft.

19. The self-drilling ground screw of claim 12, wherein the threading comprises a fin cut having angular sides of equal length.

20. The self-drilling ground screw of claim 12, wherein the flange comprises a rounded upper side.
